(19) United States
(12) Patent Application Publication
(10) Pub. No.: US 2012/0284101 A1
(43) Pub. Date: Nov. 8, 2012

(54) MOBILE TRANSACTION SERVICES

(75) Inventors: Harold J. Schiller, Silver Spring, MD (US); Dante Pacella, Charles Town, WV (US); Mark D. Carney, Sterling, VA (US)

(73) Assignee: VERIZON PATENT AND LICENSING INC., Basking Ridge, NJ (US)

(21) Appl. No.: 13/102,516

(22) Filed: May 6, 2011

(51) Int. Cl. G06Q 30/00

(52) U.S. Cl. 705/14.23; 705/16; 705/14.4

(57) ABSTRACT

A method may include receiving identification information associated with a user, where the identification information is used to store electronic receipts for the user. The method also includes receiving, from a point-of-sale device, transaction information for a transaction involving the user and generating an electronic receipt for the transaction. The method further includes storing the electronic receipt.

### BACKGROUND INFORMATION

People typically obtain many receipts during the course of the day. Keeping track of these receipts, however, is often very difficult. For example, paper receipts get lost, fade with age and/or temperature conditions, or simply get thrown away. In addition, paper receipts often contain partial credit/debit card information of a user. Including partial credit/debit card information increases the risk of fraud associated with lost paper receipts.

### BRIEF DESCRIPTION OF THE DRAWINGS

FIG. 1 illustrates an exemplary network in which systems and methods described herein may be implemented;

FIG. 2 illustrates an exemplary configuration of components implemented in one or more of the devices of FIG. 1;

FIG. 3 illustrates an exemplary configuration of logic components implemented by one of the devices of FIG. 1;

FIG. 4 illustrates an exemplary configuration of logic components implemented by another one of the devices of FIG. 1;

FIG. 5 is a flow diagram illustrating exemplary processing by various components illustrated in FIG. 1 in accordance with an exemplary implementation;

FIG. 6 is a flow diagram illustrating exemplary processing by various components of FIG. 1 in accordance with another exemplary implementation;

FIG. 7 is a signal flow diagram associated with the processing of FIG. 6;

FIGS. 8A and 8B illustrate information displayed by the user device of FIG. 1 in accordance with exemplary implementations;

FIG. 9 is a flow diagram illustrating exemplary processing associated with retrieving and reviewing electronic receipts; and

FIGS. 10A-10C illustrate exemplary information displayed by the user device of FIG. 1 in accordance with additional implementations.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to generating and storing electronic receipts. In an exemplary implementation, a mobile device may be used to perform a transaction with a retailer/vendor that includes a point-of-sale (PoS) device. The mobile device may communicate a user code or identifier to the PoS device. The PoS device may provide information associated with the transaction, along with the user code/identifier, to a device/system or program that generates and stores an electronic receipt associated with the transaction. The mobile device may also receive a copy of the electronic receipt. In some implementations, the user of the mobile device may provide categorization information to the device/system or program that allows receipts to be categorized in accordance with user-defined information.

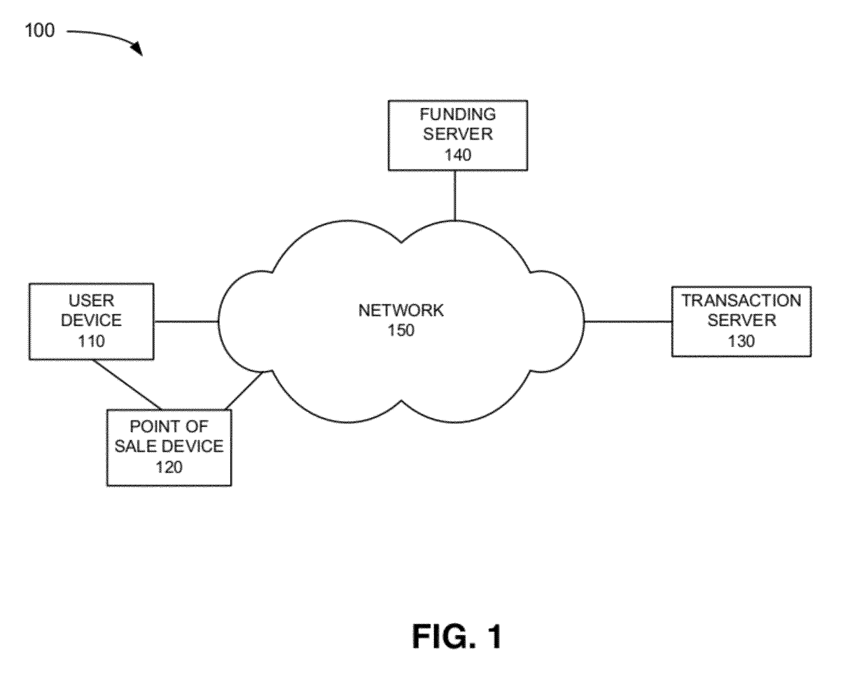

FIG. 1 is a block diagram of an exemplary network 100 in which systems and methods described herein may be implemented. Network 100 may include user device 110, point-of-sale (PoS) device 120, transaction server 130, funding server 140 and network 150.

User device 110 may represent a device associated with a party who wishes to participate in a transaction, such as making a purchase from a retailer or vendor. For example, user device 110 may include a mobile device, such as wireless or cellular telephone device (e.g., a conventional cell phone with data processing capabilities), a smart phone, a personal digital assistant (PDA) that may include a radiotelephone, etc. In another implementation, user device 110 may include any type of mobile computer device or system, such as a personal computer (PC), a laptop, a tablet computer, a notebook, a netbook, etc., that may include communication functionality. User device 110 may connect to network 150 and other devices in network 100 (e.g., PoS device 120, transaction server 130, etc.) via any conventional technique, such as wired, wireless, or optical connections. User device 110 and the person associated with user device 110 (e.g., the party holding or using user device 110) may be referred to collectively as user device 110 in the description below.

PoS device 120 may represent a device/system where a purchase may be made. For example, PoS device 120 may include an electronic cash register in a retail location or another device/system that is able to receive payment information and/or other information from user device 110. PoS device 120 may also include a scanner used to scan barcodes or other types of identification information.

Transaction server 130 may include one or more computer devices and/or servers that participate in a transaction between user device 110 and PoS device 120. In an exemplary implementation, transaction server 130 may store and/or categorize electronic receipts on behalf of user device 110, as described in detail below. In an alternative implementation, storage and/or categorization of electronic receipt data may occur in user device 110.

Funding server 140 may include one or more computer devices and/or servers responsible for approving a transaction and/or providing funding for a transaction between user device 110 and a retailer/merchant associated with PoS device 120. For example, funding server 140 may approve a credit or debit card transaction between user device 110 and PoS device 120. Alternatively, funding server 140 may be associated with an account linked to user device 110 and provide funds for transactions involving user device 110.

Network 150 may include one or more wired, wireless and/or optical networks that are capable of receiving and transmitting data, voice and/or video signals. For example, network 150 may include one or more public switched telephone networks (PSTNs) or other type of switched network. Network 150 may also include one or more wireless networks and may include a number of transmission towers for receiving wireless signals and forwarding the wireless signals toward the intended destination. Network 150 may further include one or more satellite networks, one or more packet switched networks, such as an Internet protocol (IP) based network, a local area network (LAN), a wide area network (WAN), a personal area network (PAN), a WiFi network, a Bluetooth network, an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, network 100, may include thousands of user devices 110, point of sale devices 120, transaction servers 130 and funding servers 140. In addition, network 150 may include additional elements, such as switches, gateways, routers, etc., that aid in routing data.

Further, various functions are described below as being performed by particular components in network 100. In other implementations, various functions described as being performed by one device may be performed by another device or multiple other devices, and/or various functions described as being performed by multiple devices may be combined and performed by a single device.

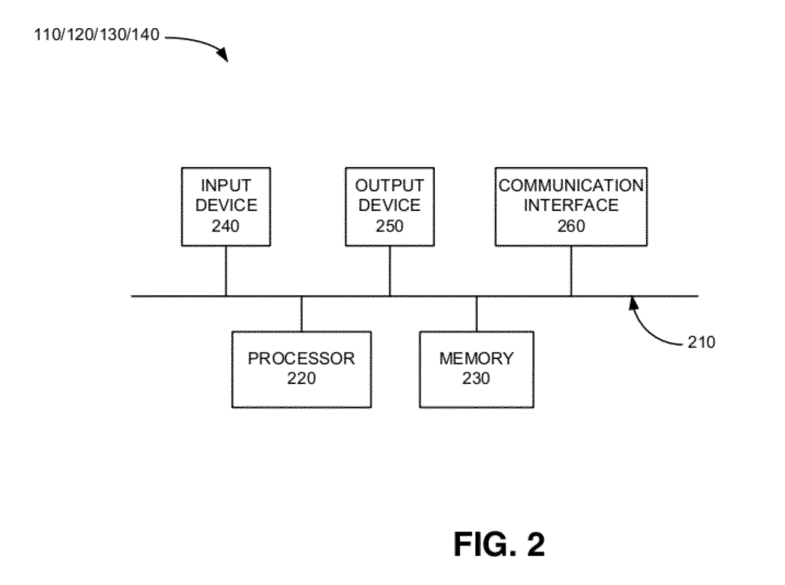

FIG. 2 illustrates an exemplary configuration of user device 110. Other devices in network 100, such as PoS device 120, transaction server 130 and funding server 140 may be configured in a similar manner. Referring to FIG. 2, user device 110 may include bus 210, processor 220, memory 230, input device 240, output device 250 and communication interface 260. Bus 210 may include a path that permits communication among the elements of user device 110.

Processor 220 may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that may store static information and instructions for use by processor 220. Memory 230 may further include a solid state drive (SSD). Memory 230 may also include a magnetic and/or optical recording medium (e.g., a hard disk) and its corresponding drive.

Input device 240 may include a mechanism that permits a user to input information to user device 110, such as a keyboard, a keypad, a mouse, a pen, a microphone, a touch screen, voice recognition and/or biometric mechanisms, etc. Output device 250 may include a mechanism that outputs information to the user, including a display (e.g., a liquid crystal display (LCD)), a printer, a speaker, etc. In some implementations, a touch screen display may act as both an input device and an output device.

Communication interface 260 may include a transceiver that user device 110 (or PoS device 120, transaction server 130, funding server 140) uses to communicate with other devices via wired, wireless or optical mechanisms. Communication interface 260 may also include one or more radio frequency (RF) transmitters, receivers and/or transceivers and one or more antennas for transmitting and receiving RF data via network 150.

For example, communication interface 260 may include a radio frequency identification (RFID) system/interface that allows user device 110 to transmit and/or receive information associated with user device 110 to, for example, PoS device 120. In some implementations, communication interface 260 may include a near field communications (NFC) interface that allows user device 110 to communicate with PoS device 120. For example, an NFC system/interface in user device 110 may include a short range, high frequency system that enables the short range exchange of data with another device (e.g., PoS device 120) that includes a similar NFC system/interface.

Communication interface 260 may also include a modem or an Ethernet interface to a LAN or other mechanisms for communicating with elements in a network, such as network 150 or another network.

The exemplary configuration illustrated in FIG. 2 is provided for simplicity. It should be understood that user device 110, PoS device 120, transaction server 130 and funding server 140 may include more or fewer devices than illustrated in FIG. 2. In an exemplary implementation, user device 110 (or PoS device 120, transaction server 130 and funding server 140) perform operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 260. Alternatively, hard-wired circuitry may be used in place of or in combination with software instructions to implement processes consistent with the implementations described herein. Thus, implementations described herein are not limited to any specific combination of hardware circuitry and software.

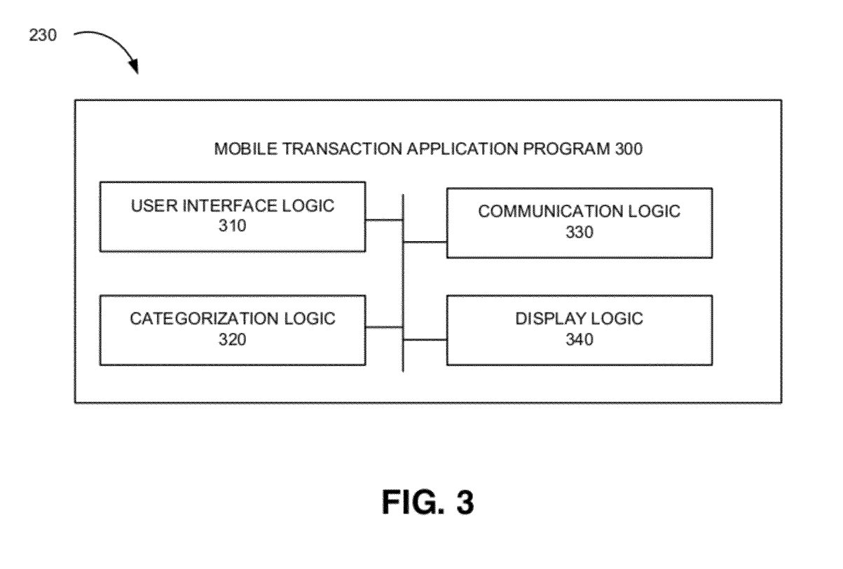

FIG. 3 is an exemplary functional block diagram of components implemented in user device 110 of FIG. 2. In an exemplary implementation, all or some of the components illustrated in FIG. 3 may be stored in memory 230. For example, referring to FIG. 3, memory 230 may include mobile transaction application (MTA) program 300. MTA program 300 may include software instructions executed by processor 220 that allows a party associated with user device 110 to manage receipts issued by various parties.

MTA program 300 may include user interface logic 310, categorization logic 320, communication logic 330 and display logic 340. MTA program 300 and its various logic components are shown in FIG. 3 as being included in user device 110. In alternative implementations, these components or a portion of these components may be located externally with respect to user device 110.

User interface logic 310 may include logic to facilitate entry of information associated with managing receipts. For example, user interface logic 310 may include a graphical user interface (GUI) that allows a user to easily enter information to request how his/her receipts will be electronically stored and organized. As an example, the GUI provided by user interface logic 310 may include a number of drop down menus that allow a user to select categories associated with receipts, such as business, personal, electronics, medical, vacation, etc. The GUI may further provide a number of drop down menus that allow the user to select particular stores/retailers associated with each category. For example, the user may select or enter “Staples” and “OfficeMax” for the business-related category, and select/enter “Best Buy” and “The Apple Store” for electronics. As another example, the user may provide information that all receipts from a pharmacy or a doctor's office should be categorized as medical expenses.

Categorization logic 320 may include logic associated with categorizing and storing receipts in accordance with information provided by the user via user interface logic 310. For example, continuing with the example above in which receipts from Staples and Office Max were selected as being business-related, categorization logic 320 may store all receipts from these two stores and other stores falling within the office supply category as business receipts. The categorized receipts may then be retrieved as a group, as described in detail below.

Communication logic 330 may include logic for communicating with other devices in network 100. For example, communication logic 330 may transmit and/or receive information to/from PoS device 120 and transaction server 130 via wired or wireless mechanisms.

Display logic 340 may include logic to display information received from, for example, transaction server 130. In one exemplary implementation, display logic 340 may output information to output device 250, such as an LCD or another type of display. For example, in one implementation, display logic 340 may display a mobile transaction code (MTC) or other identifier particularly associated with user device 110. A retailer associated with PoS device 120 may scan the MTC or otherwise receive the MTC when a transaction/purchase is taking place. In addition, display logic 340 may output an electronic receipt and other information received from PoS device 120 and/or transaction server 130 after the transaction is completed.

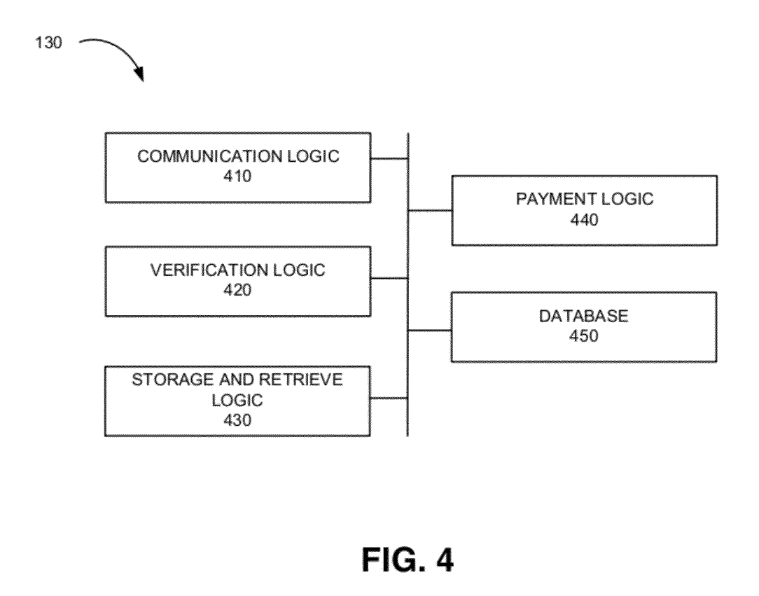

FIG. 4 illustrates an exemplary configuration of logic components implemented in transaction server 130. Referring to FIG. 4, transaction server 130 may include communication logic 410, verification logic 420, storage and retrieve logic 430, payment logic 440 and database 450. It should be understood that transaction server 130 may include more or fewer logic devices than illustrated in FIG. 4.

Communication logic 410 may include logic that allows transaction server 130 to communicate with other devices in network 100 via network 150. For example, communication logic 410 may allow transaction server 130 to communicate with user device 110, PoS device 120 and funding server 140 via network 150.

Verification logic 420 may include logic for processing transactions between various parties, such as a party associated with user device 110 and a merchant associated with PoS device 120. For example, verification logic 420 may identify the party at user device 110 and process an electronic receipt in accordance with information provided by user device 110 and PoS device 120.

Storage and retrieve logic 430 may include logic for storing and retrieving transaction information in database 450. For example, storage and retrieve logic 430 may store electronic receipts for a large number of users in database 450 in accordance with categorization information provided by each of the users via, for example, MTA program 300 running in each of a number of user devices 110 associated with different users.

Payment logic 440 may include logic associated with determining whether to approve a transaction between user device 110 and PoS device 120. In one implementation, payment logic 440 may access an external resource, such as funding server 140, to verify a user's payment information and/or provide additional information regarding the party associated with user device 110. In other implementations, transaction server 130 may be associated with an account of a party associated with user device 110 and may determine whether the user's account in transaction sever 130 has adequate funds to cover a purchase.

Database 450 may include one or more databases of information associated with electronic receipts. For example, database 450 may include a database of receipts associated with a large number of parties. As an example, database 450 may store electronic receipts for a user at user device 110 in accordance with parameters provided via MTA program 300. The user may access these receipts in database 450 via network 150, as described in detail below. Database 450 may also include a database of coupons or other discount information associated with purchases made by parties in network 100. This information may be provided to user device 110 and/or PoS device 120 when a transaction is taking place, as described in detail below.

In an exemplary implementation, communication logic 410, verification logic 420, storage and retrieve logic 430, payment logic 440 and database 450 may include one or more processors, microprocessors or other processing logic, such as processor 220 (FIG. 2) used to interpret and execute instructions. In such implementations, the logic components may include software instructions stored in a computer-readable medium, such as memory 230. A computer-readable medium may be defined as one or more memory devices. The software instructions may be read into memory from another computer-readable medium or from another device via a communication interface. The software instructions contained in memory may cause the various logic components to perform processes that are described below. Alternatively, hardwired circuitry may be used in place of or in combination with software instructions to implement the logic processes consistent with the exemplary embodiments. Thus, systems and methods described herein are not limited to any specific combinations of hardware circuitry, firmware, and software.

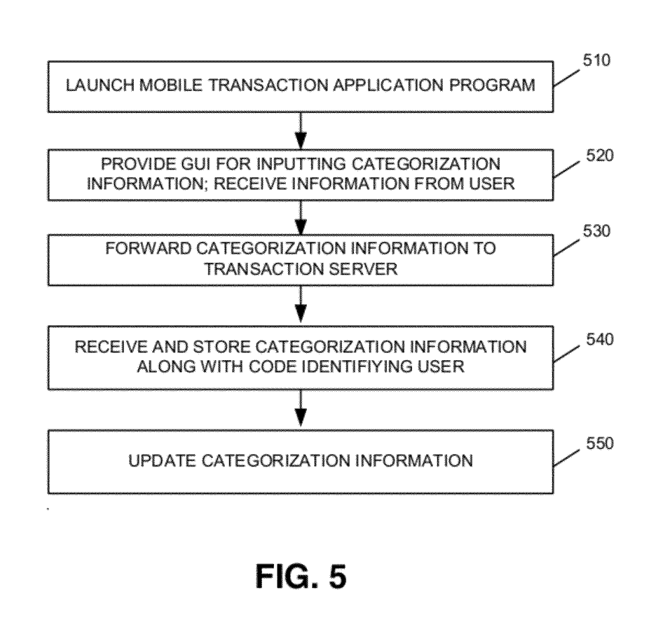

FIG. 5 is a flow diagram illustrating exemplary processing associated with managing receipts in network 100. In this example, assume that a party associated with user device 110 would like to set up parameters associated with managing his/her electronic receipts. Processing may begin with the user launching MTA program 300 (block 510). For example, assume that user device 110 is a cell phone that stores MTA program 300. The user may access a menu or user interface on the cell phone and open/launch MTA program 300. After launching MTA program 300, user interface logic 310 may provide a GUI to facilitate the inputting of information regarding the storage and handling of electronic receipts (block 520).

For example, user interface logic 310 may include a GUI that provides one or more drop down menus that request information regarding how the user would like to categorize various receipts. As discussed above with respect to FIG. 3, the user may want to categorize certain types of expenses as business expenses (e.g., purchases from office supply stores, such as Staples, OfficeMax, etc.). The user may also want to create other categories, such as personal/family, electronics, health care, vacation, etc. After receiving information from the user with respect to creating the various categories, the GUI may request that the user select or input names of particular retailers in each category. For example, the user may enter “Staples” and “Office Max” for the business-related category. Alternatively, the GUI may be pre-populated with names of retailers for each category and the user may select from the available entries. In still other alternatives, the GUI fields may be populated based on Global Positioning System (GPS) data, thus allowing rapid access to receipts, preferences, shopping lists and/or prebuilt or previous orders for one or more stores near the user's present location.

After the user inputs the category information and provides or selects names of retailers/merchants for each category, MTA program 300 may receive and store this information in memory 230 (block 520). User device 110 may also forward the categorization information to transaction server 130, along with a code or information particularly identifying user device 110 (block 530). For example, communication logic 330 of MTA program 300 may forward the user-supplied category information and retailer information for each category to transaction server 130, along with an MTC that particularly identifies user device 110. For example, MTA program 300 may include a unique MTC such that each user device 110 executing an MTA program 300 has a unique MTC.

Transaction server 130 may receive the information from user device 110 and store this information in database 450 (block 540). For example, communication logic 410 of transaction server 130 may receive the information and storage and retrieve logic 430 may store this information in database 450. That is, database 450 may be set up to include fields that correspond to the categorization information provided by user device 110 such then when receipts or transaction information associated with purchases by user device 110 are received by transaction server 130, storage and retrieve logic 430 will store the electronic receipts/transaction information in accordance with the user-provided information. In other words, the receipts will be categorized based on the user-defined criteria. This may allow for easy recall and/or review of the receipts at a later time via user device 110.

The user at user device 110 may also update the categorization information at a later time (block 550). For example, if the user decides to enter a new category for receipts, such as education-related receipts, or add a new store associated with a particular category, the user may access MTA program 300, update the information and forward the information to transaction server 130. Storage and retrieve logic 430 may then update database 450 with respect to user device 110 such that purchases and receipts associated with user device 110 are properly categorized. After the user has provided the information described above in MTA program 300, MTA program 300 may interact with PoS device 120 and transaction server 130 when a transaction in network 100 occurs, as described in detail below.

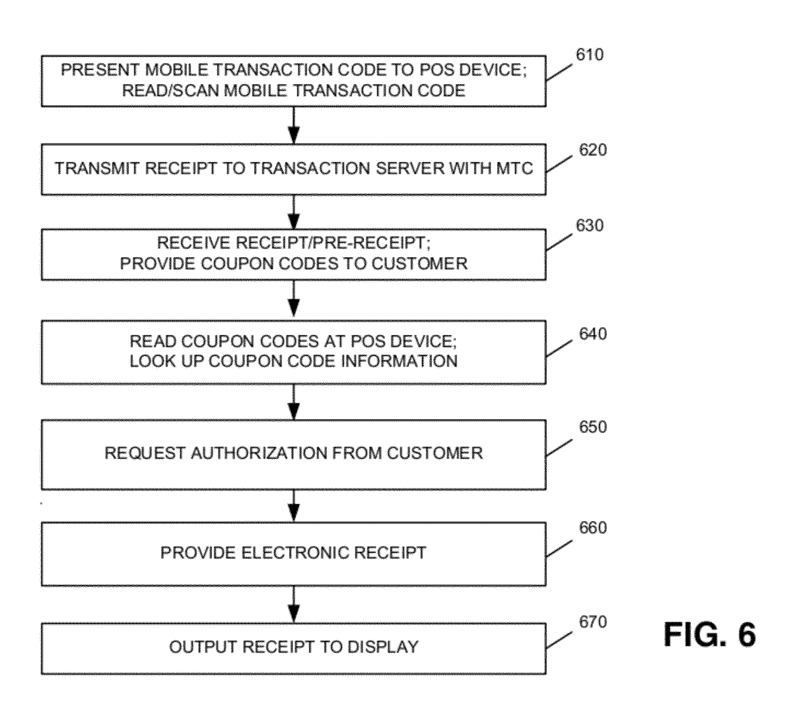

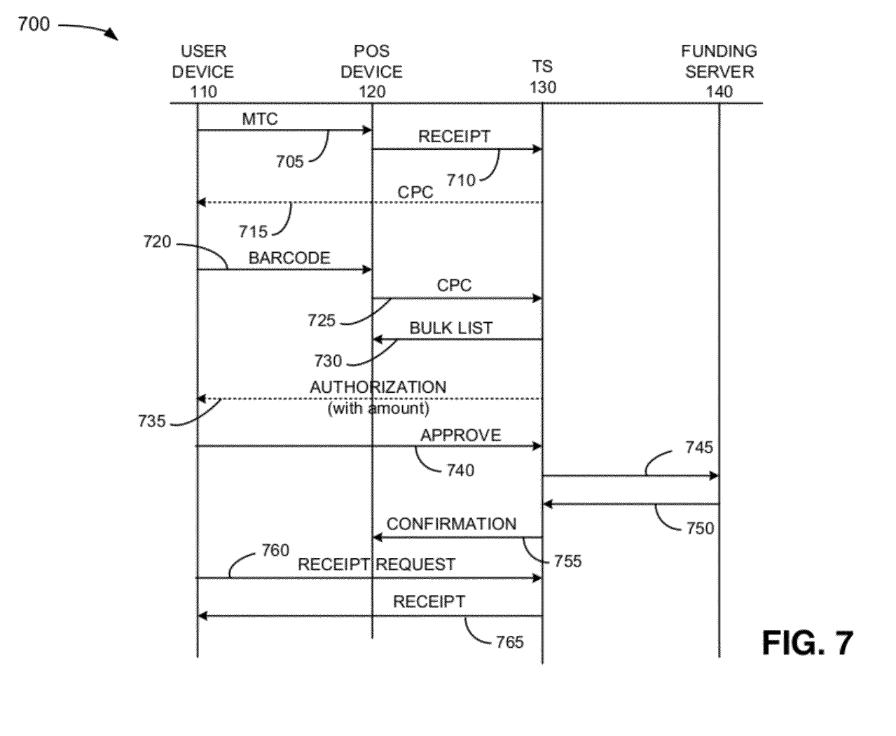

FIG. 6 illustrates exemplary processing associated with a transaction in network 100. FIG. 7 is an exemplary signal flow diagram associated with the processing described in FIG. 6 and will be described in conjunction with the flow diagram of FIG. 6. In this example, assume that the user (also referred to herein as the customer) associated with user device 110 would like to make a purchase at a retail location associated with PoS device 120. Processing may begin with the user launching MTA program 300 in user device 110 and making a purchase at point-of-sale device 120. In this example, assume that the user of user device 110 presents the MTC associated with MTA program 300 to the clerk associated with PoS device 120 (FIG. 6, block 610). In one implementation, the MTC may be in machine readable form, such as a barcode that is displayed on user device 110

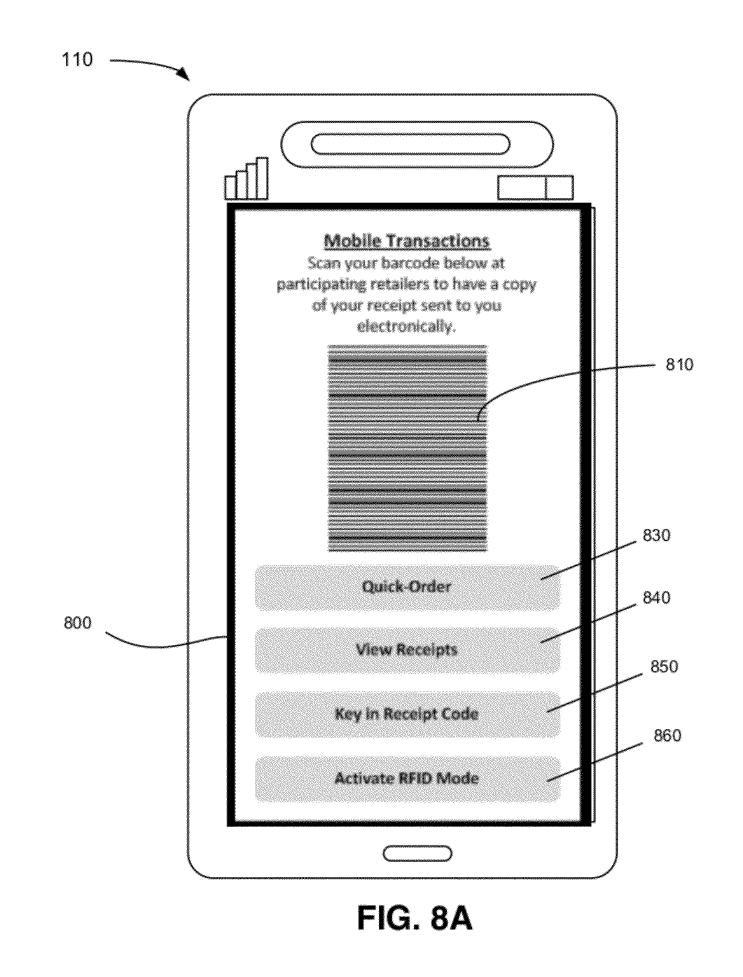

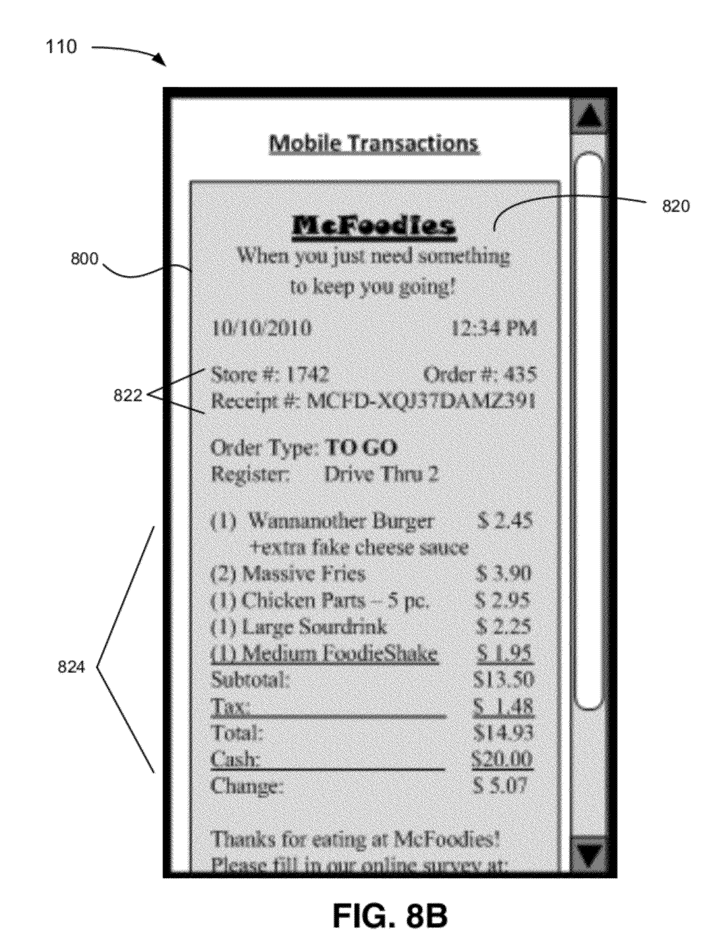

For example, FIG. 8A illustrates user device 110 in which output device 250 is a display screen 800, such as an LCD. Display 800 may provide barcode 810, which corresponds to the MTC associated with user device 110. The customer associated with user device 110 may provide or present this barcode for reading/scanning at PoS device 120. Assume that a clerk at PoS device 120 scans barcode 810 using a scanner (block 610; FIG. 7, 705).

In some implementations, the MTC provided by user device 110 may be linked with or provide the vendor at PoS device 120 with the ability to automatically look up and/or retrieve the customer's shopper profile that may provide for automatic discounts, special offers, etc. Linking the customer's MTC to a retailer's valued/repeat shopper profile that provides for various benefits (e.g., automatic discounts, coupons, etc.) may eliminate the need for the customer to carry separate valued customer cards, fobs, etc., that must be provided to the retailer at check-out time.

The MTC provided by user device 110 also provides PoS device 120 with the customer's unique receipt service identifier (ID). For example, as discussed above, MTA program 300 may be assigned a unique service ID (i.e., MTC) that particularly identifies user device 110. This information may be used by transaction server 130 to handle electronic receipts in accordance with customer supplied information.

As described above, PoS device 120 scans/receives the MTC at the time the transaction occurs (e.g., at any time before the transaction is completed) and transmits a copy of a detailed receipt, or a pre-receipt detail if payment has not been made by customer 110, to transaction server 130 (block, 620; FIG. 7, 710). PoS device 120 may also send a unique transaction or receipt ID to MTS 130, along with the detailed receipt. The receipt ID may be later used to identify a particular receipt. In some implementations, the detailed receipt sent by PoS device 120 may include a universal product code (UPC) or other unique product ID associated with each item that is being purchased. PoS device 120 may also transmit serial numbers associated with one or more of the items being purchased to transaction server 130.

Transaction server 130 receives the information from PoS device 120 (block 630). In one implementation, based on the universal product codes (UPC(s)) and/or serial numbers associated with the purchased products, transaction server 130 may transmit one or more advertising based coupon codes or a coupon pack code (CPC) to MTA program 300 at user device 110 (block 630, FIG. 7, dotted line 715). For example, communication logic 330 may receive the CPC information from transaction server 130 and display logic 340 on user device 110 may display the CPC as a barcode on display 800. PoS device 120 may scan the barcode(s) displayed by user device 110 (block 640, FIG. 7, 720), similar to the way that traditional paper coupons may be scanned. That is, the barcode(s) may be scanned by a scanner at PoS device 120 and any associated discounts may be applied to the purchase. Any such discounts information may also be provided to transaction server 130. In other implementations, the CPC information may be automatically transmitted to PoS device 120 via an RF link (e.g., RFID, NFC, etc.).

PoS device 120 may also perform a lookup at transaction server 130 (or some other designated server) by sending the CPC to transaction server 130 (or the designated alternate server) (FIG. 7, 725). In an exemplary implementation, transaction server 130 receives the CPC from PoS device 120 and performs a lookup based on the received CPC(s) (block 640). Transaction server 130 may then send PoS device 120 a bulk list of related coupons from relevant advertising or manufacturer offers (FIG. 7, 730). In other implementations, transaction server 130 may send the bulk list of coupons/codes directly to PoS device 120, when PoS device 120 is configured to identify the particular CPC(s). In such implementations, signal flows 715-725 may be eliminated.

In some implementations, the total amount associated with the transaction between user device 110 and PoS device 120 may be charged against or debited from funding sources associated with the customer's account with transaction server 130. That is, the customer may have an account with transaction server 130 that also handles payments. In this case, the entity associated with transaction server 130 may receive a processing fee associated with the transaction. If more than one funding source associated with the customer is available or the customer's pre-defined settings require mobile authorization for the transaction type or amount, transaction server 130 may send a request for authorization associated with the charges to user device 110 (block 650).

Continuing with this example, assume that funding authorization is needed. In this case, MTA program 300 at user device 110 may receive the request, along with the amount of the transaction (FIG. 7, dotted line 735). The request may be output to display 800 and the user may accept or deny the request. In this example, assume that the user inputs/selects a response indicating that the request is approved. MTA program 300 may send a response to transaction server 130 indicating the request is approved (FIG. 7, 740).

In some implementations, transaction server 130 may exchange information regarding the transaction with funding server 140. For example, funding server 140 may represent a bank associated with a credit or debit card. In this case, transaction server 130 may send an amount of the transaction to funding server 140 (FIG. 7, 745). Funding server 140 may identify whether adequate funds exist in the customer's account and approve/deny the transaction (FIG. 7, 750).

In other implementations, funding server 140 may store information associated with an account linked to user device 110 and provide funds for transactions involving user device 110. In such implementations, funding server 140 may determine if adequate funds exist in the customer's account and debit the amount of the transaction from the customer's account.

In either case, assume that funding server 140 determines that the request should be approved. Transaction server 130 may send a confirmation to PoS device 120 indicating that the transaction is approved (FIG. 7, 755).

After the confirmation is sent, MTA program 300 may automatically request a copy of the receipt from transaction server 130 via network 150 (e.g., over cellular, WiFi, or other networks) (FIG. 7, 760). Transaction server 130 may receive the request and send a copy of finalized receipt to MTA program 300 (block 660; FIG. 7, 765). In other implementations, transaction server 130 automatically sends a receipt to MTA program 300 upon completion of a transaction without requiring a request for the receipt to be made. In each case, the electronic receipt may provided/output in a viewable format with optional levels of detail (block 670).

For example, FIG. 8B illustrates an exemplary electronic receipt 820 provided on display 800 of user device 110. As illustrated in FIG. 8B, receipt 820 includes information at area 822 that is particular to the order, such as a store number, an order number and a receipt number. Receipt 820 also includes details of the purchase at area 824, such as the particular products purchased, cost, tax, etc.

In this manner, a customer may receive an electronic receipt for a transaction and avoid having to keep a paper copy of the receipt. In addition, transaction server 130 may store other receipts associated with transactions involving user device 110 and a large number of retail locations/vendors similar to PoS device 120. Transaction server 130 may store these transactions in database 450 in accordance with the user-defined criteria discussed above with respect to FIG. 5. The user may then view these receipts at a later time, as described in detail below.

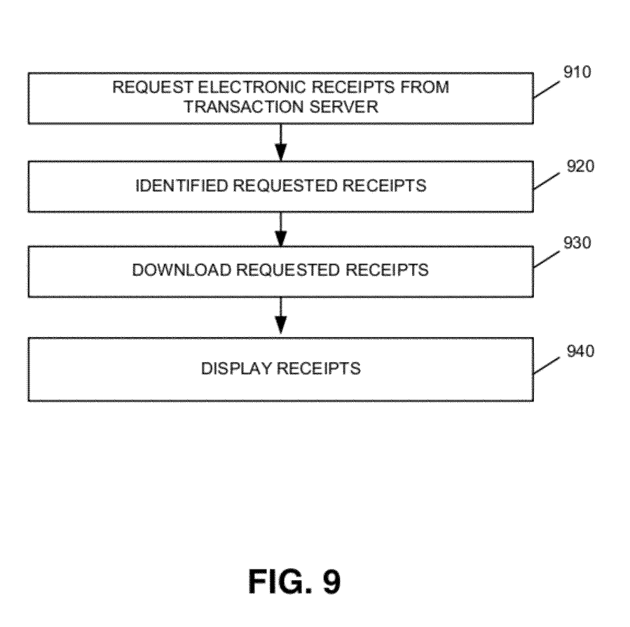

FIG. 9 illustrates processing associated with accessing electronic receipts in network 100. Processing may begin with a customer at user device 110 launching MTA program 300. Once MTA program 300 is launched, user interface logic 310 may output a screen to allow a user to view receipts. For example, referring back to FIG. 8A, user interface logic 310 may output barcode 810 to display 800 (described above), along with a number of other options/selections, such as a quick order option 830, a view receipts option 840, a key in receipt code option 850 and an activate RFID mode option 860.

Assume that the user selects view receipts option 840 (block 910). In this case, communication logic 330 may forward the selection associated with requesting receipts to transaction server 130, along with the customer's MTC (block 910).

Verification logic 420 at transaction server 130 may identify the customer based on the received MTC. Storage and retrieve logic 430 may then access database 450 and identify receipts associated with the customer identified by the received MTC (block 920). Communication logic 410 of transaction server 130 may then download the receipts to user device 110 via network 150 (block 930). User device 110 may receive the receipts and display the receipts to the user via display 800 (block 940).

For example, in some implementations, after the receipts are downloaded to user device 110, display logic 340 may output small thumbnail summaries or snippets of each of the business-related receipts. Alternatively, business and personal receipts may be displayed with different borders, background colors or other forms of highlighting. The user may then select any of the snippets/thumbnails to view the full, detailed receipt.

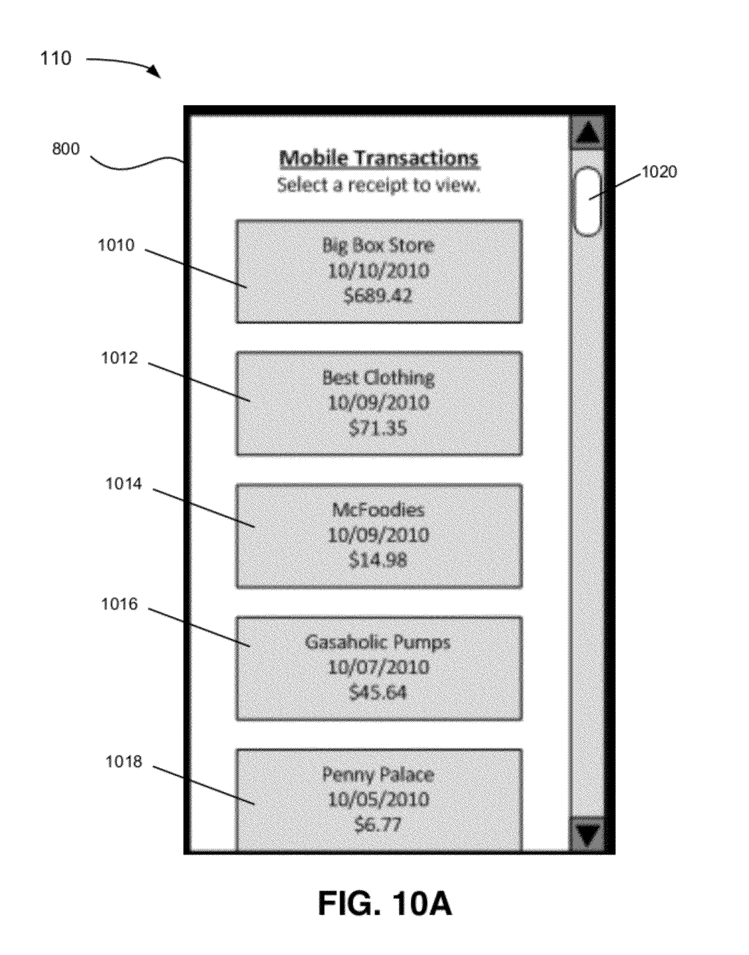

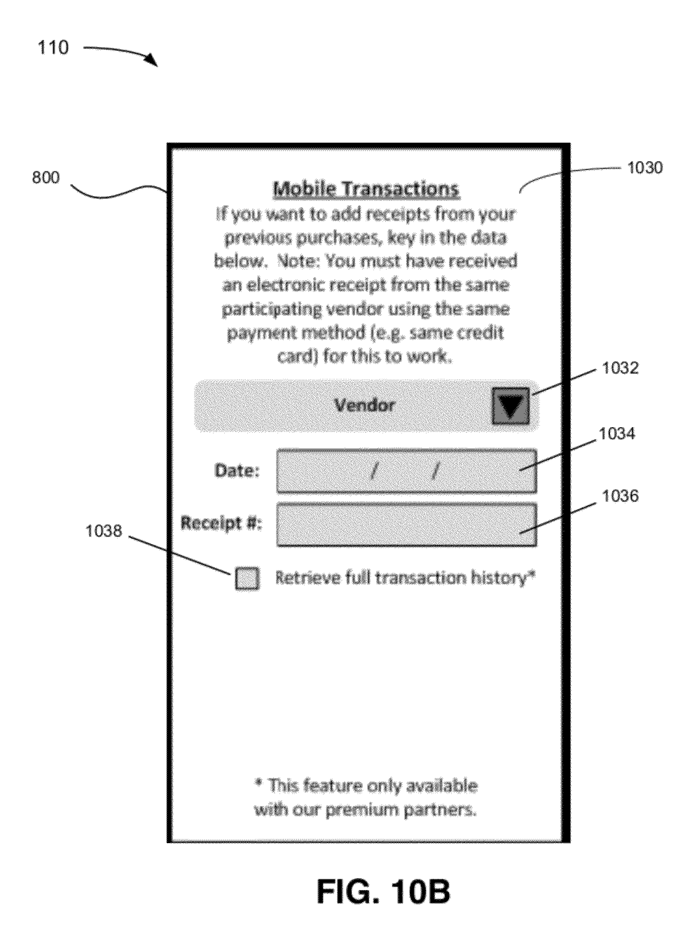

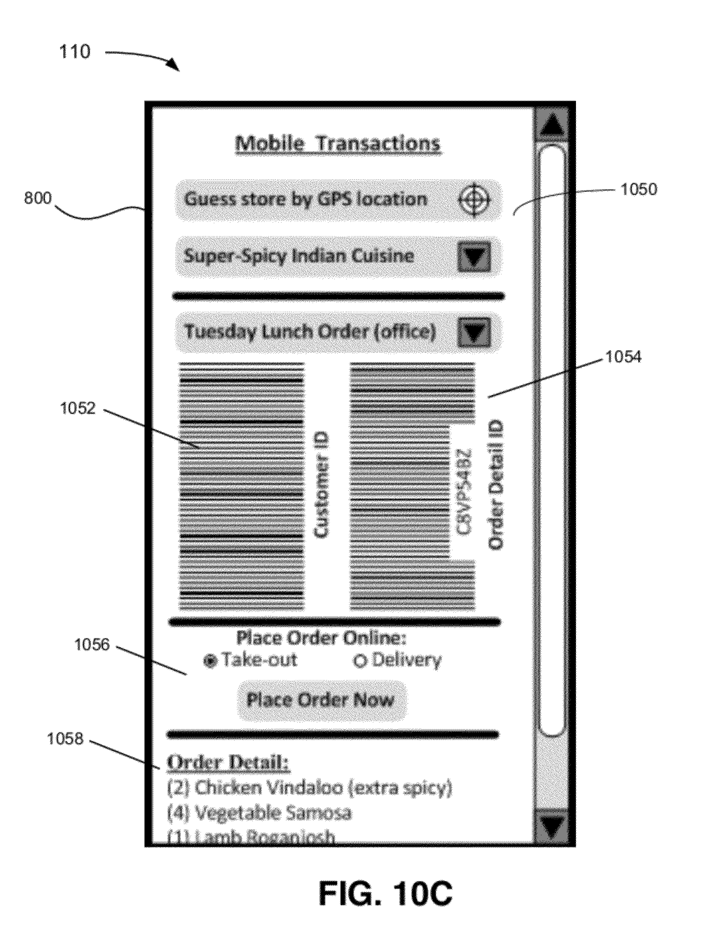

For example, FIG. 10A illustrates an exemplary output on display 800. Referring to FIG. 8A, a number of brief summaries of receipts, labeled 1010, 1012, 1014, 1016 and 1018, are provided on display 800. The user may also use scroll bar 1020 to scroll down to view additional receipts. The user may further select any of the summary receipts to view a detail receipt for the particular transaction. For example, the user may select summary 1014 and receive a detailed receipt, as illustrated in FIG. 8B.

In some implementations, user interface logic 310 may provide an option to allow the user to enter information regarding the particular types of receipts he/she would like to view. As an example, the GUI may provide inputs/options to select any of the categories of receipts previously entered by the customer. For example, the GUI may provide selections for business-related receipts, medical receipts, vacation receipts, etc. In this example, assume that the user selects business-related receipts. Display logic 340 may then output brief “thumbnail” summaries or snippets associated with each of the business-related receipts, and not include summaries of other types of receipts (e.g., medical receipts, vacation receipts, etc.). The user may then select any of the snippets/thumbnails to view the full, detailed receipt.

In some implementations, receipts associated with particular vendors may be added to other receipts stored by transaction server 130. For example, user interface logic 310 of user device 110 may include an option to add receipts from previous purchases, as illustrated in FIG. 10B. Referring to FIG. 10B, display 800 may provide screen 1030 which allows the user to enter a particular vendor name via a drop down menu (labeled 1032), add a date of a receipt and a receipt number via input boxes 1034 and 1036, respectively. The user may also select input box 1038 to receive a full, detailed receipt. Transaction server 130 may receive the request to add a receipt and may communicate with the particular vendor to retrieve the receipt of interest. Transaction server 130 may then provide the receipt to user device 110.

As described in the exemplary implementation above, the MTC associated with user device 110 may be a barcode or other type of code displayed on an output device (e.g., an LCD) of user device 110. A scanner at PoS device 120 may then scan the barcode. In other implementations, the MTC/presented ID associated with MTA program 300 may be some form of radio frequency ID (RFID) built into user device 100. For example, MTA program 300 may include an RFID interface that transmits an MTC associated with user device 110 to PoS device 120. Alternatively, PoS device 120 may query user device 110 to transmit the MTC to PoS device 120 in response to the query. In such implementations, user device 110 may include processing logic to disable/scramble or fuzz the RFID portion when the RFID in not in active use and prevent unauthorized interception of the RFID information.

For example, referring back to FIG. 8A, user device 110 may include an activate RFID mode option 860. When the user selects option 860, the RFID interface in user device 110 may be activated to transmit the MTC to PoS device 120. At other times, the RFID interface in user device 110 may be disabled.

In still other implementations, user device 110 may include smart-card functionality embedded in user device 110, or implemented in a sleeve or cover that fits around user device 110. In still other implementations, user device 110 may include a near field communication (NFC) interface that communicates with an NFC interface at PoS device 120 in similar manner as the RFID mode discussed above. However, in the NFC mode, user device 110 may come in close proximity to PoS device 120 to exchange the MTC code and/or other information.

As described above, user device 110 may receive electronic receipts from transaction server 130. In some implementations, each digital receipt provided by transaction server 130 may include a timestamp to prevent replay attacks or fraud by a customer. For example, referring to FIG. 8B, receipt 820 may include a timestamp indicating the time of purchase. Such timestamps may be used to prevent fraud by a customer.

For example, suppose that a user associated with user device 110 purchased a television at an electronics store. In this case, the electronic receipt provided to user device 110 may include the time of purchase. When the user leaves the store, the clerk at the exit may verify the receipt against the merchandise being taken from the store and also verify the time of purchase. In this manner, the user may not be able to return to the store at a later time (e.g., hours later) and remove another television from the store based on the original receipt since the original receipt includes time stamp information. The electronic receipt output to display 800 may also contain barcodes and other forms of computer-readable information to make exit-processing easier and faster.

Further, in some implementations, each receipt is given a unique ID that aid in preventing replay attacks, as well as verifying receipts during returns/exchanges. For example, referring back to FIG. 8B, receipt 820 includes a particular receipt number. This information may be used when a product is returned.

For example, PoS device 120 may communicate with transaction server 130 when a product is returned to update database 450 to indicate that the product was returned. As an example, transaction server 130 may red-line or use a strike-through font/modifier to indicate the items no longer covered by that receipt. In this manner, when user device 110 displays a particular receipt, the returned items will be clearly identified. A return-receipt may also be associated with an original receipt for ease-of-reference.

The receipt number may also be used to recall a particular receipt at a later time. For example, referring to FIG. 8A, display 800 includes a “key in receipts code” option 850. The user may enter the particular receipt code and user device 110 may retrieve the particular receipt from transaction server 130.

Still further, in some implementations, each receipt may include other fields, such as an operator/cashier ID, register number, etc. Including such information in an electronic receipt may help businesses monitor fraud, including internal fraud, such as a cashier undercharging a customer. In other implementations, an electronic receipt may be linked to this type of information (e.g., receipt number, cashier ID, register number, etc.) stored at another location to allow for internal auditing of cashiers.

In still other implementations, each electronic receipt may include embedded uniform resource locators (URLs) or links associated with surveys, product registries, etc. In other implementations, promotional links (e.g., URLs) may be embedded in the electronic receipts to allow the user to view other products or promotions. Barcodes may also be included on the electronic receipts. These barcodes may be scanned for future discounts or promotions. In some implementations, the promotional links or barcodes may be tied to participating in surveys or product registries.

As also described above, customers may have receipts automatically categorized by store (e.g., The Apple Store and Best Buy receipts would be categorized as “electronics,” restaurant receipts would be categorized as “food,”, doctor's office receipts would be categorized as “medical,” etc.). Alternatively, the contents of a single receipt could be spread across multiple categories, with food items at a discount club being categorized as “food,” pharmaceuticals items being categorized as “medical,” etc. In such implementations, codes associated with different items may be used to categorize the item in the proper category.

Further, in some implementations, each receipt or item may be flagged as either “business” or “personal” to aid in identifying quarterly and/or annual tax information. For example, transaction server 130 and/or user device 110 may automatically calculate total taxes paid associated with purchases made by user device 110. This may be beneficial in generating tax returns (e.g., in deducting sales and food taxes).

MTA program 300 may also perform other transactions for customers. For example, as described above, the customer's account may be linked to a funding source. In some implementations, the customer's account may be linked to multiple funding sources. In such implementations, the user may select the funding source(s) to use for each particular transaction, amounts available from each source, view available balances, identify minimum reserves or maximum spending limits, etc. In this case, transaction server 130 may act as the payment processor and the entity associated with transaction server 130 may receive a small percentage fee for each transaction.

As described above, a customer, via user device 110, may interface with a PoS device 120 to make a transaction and have an electronic receipt generated for the transaction. In some implementations, user device 110 may be used with retailers/vendors that do not have PoS system. For example, user device 110 may include an application programming interface (API) to interface with vendors that do not have a PoS system. In such cases, instead of a receipt being mailed to a payee at a cost of several cents postage plus printing expenses, the vendor's system may make an automated call to the API at user device 110 to provide a digital receipt to the payee (i.e., the customer associated with user device 110), as proof of payment.

As another example, a utility company processing hundreds of thousands of payments per month could save a significant amount on printing and postage by providing an electronic receipt to user device 110. The digital receipts may look the same as printed ones with virtually no cost associated with generating and distributing the receipts. This may also provide a “green” or environment-friendly paperless billing/receipts process.

Still further, MTA program 300 may be used to simplify sales and/or orders. For example, suppose that a customer wants brand X shoes in model Y and size Z. Of the vendors in-network (e.g., participating vendors), MTA program 300 may receive electronic information from vendors that have the desired product for sale, such as information identifying the price and shipping cost to the customer's address of record. The user may then simply order the item from the desired vendor.

As another example, suppose that the customer would like to place an order with a restaurant that typically gets something wrong with respect to orders placed over the telephone. If the restaurant subscribes to a market service associated with MTA program 300, the customer can place an order via user device 110 to ensure that the restaurant will get the correct order. In this case, when the restaurant receives the order and totals the charges, an electronic receipt/pre-receipt may be provided to user device to verify both the order and the cost. This reduces errors, customer frustration, labor costs, and even material costs from corrections.

For example, FIG. 10C illustrates an output screen 1050 provided on display 800. In this example, screen 1050 includes a customer ID 1052 and a customer order detail 1054 displayed as a bar code. Area 1056 may indicate whether the order is a take out or delivery order and area 1058 may provide details of the order in a textual format. The user may review the order details and approve/decline the order. In this manner, errors with respect to orders may be reduced or eliminated, thereby reducing customer frustration, labor costs, and even material costs associated with incorrect orders.

As described above, MTA program 300 may provide electronic receipts to a customer. The itemized nature of the electronic receipts combined with details regarding each receipt may alleviate problems associated with customers trying to remember cryptic/abbreviated information printed on a small paper receipt. For example, a customer does not have to remember or try to determine that the label “Org Crd Stk” refers to orange card stock ordered for a business presentation/posters. That is, the customer can select the item identified on an electronic receipt and have full product information (optionally including a picture) shown or displayed on user device 110. This may help the customer avoid problems with respect to claiming business deductions at tax time.

Implementations described herein provide for the generating and storage of electronic receipts. As described above, a mobile device may be used to perform a transaction with a retailer/vendor that includes a point-of-sale (PoS) device and an electronic receipt for the transaction may be provided to the mobile device. In addition, electronic receipts may be categorized based on user-defined criteria. This may allow for easy recall and use of the electronic receipts.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been described above with respect to transaction server 130 storing receipts on behalf of a customer at user device 110. In other implementations, user device 110 may interact with PoS device 120 and receive electronic receipts without requiring interaction with transaction server 130.

Further, while series of acts have been described with respect to FIGS. 5, 6 and 9, and various signal flows have been described with respect to FIG. 7, the order of the acts and/or signal flows may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A computer-readable medium having stored thereon sequences of instructions which, when executed by at least one processor, cause the at least one processor to:
store an identifier associated with a user of a mobile device;
provide a user interface configured to:
receive input from the user, the input identifying categorization information associated with storing electronic receipts for the user;
provide the identifier or display the identifier, via the mobile device, to a point-of-sale device associated with a retailer; and
receive an electronic receipt associated with a transaction between the user and the retailer.

2. The computer-readable medium of claim 1, wherein the instructions for providing the identifier or displaying the identifier cause the at least one processor to:
output the identifier to a display screen of the mobile device.

3. The computer-readable medium of claim 2, wherein the identifier comprises a barcode.

4. The computer-readable medium of claim 1, wherein the instructions for providing the identifier or displaying the identifier cause the at least one processor to:
forward the identifier via a radio frequency communication interface.

5. The computer-readable medium of claim 1, further including instructions for causing the at least one processor to:
forward the categorization information to an external system that is configured to store the electronic receipt.

6. The computer-readable medium of claim 5, wherein the instructions for causing the at least one processor to receive the electronic receipt cause the at least one processor to receive the electronic receipt from the external system.

7. The computer-readable medium of claim 1, further comprising instructions for causing the at least one processor to:
access an external system storing a plurality of receipts associated with the user; and
retrieve at least some of the plurality of receipts from the external system, wherein the receipts are stored in accordance with the categorization information.

8. The computer readable medium of claim 7, further comprising instructions for causing the at least one processor to:
receive, from the user, information identifying a first category associated with stored receipts; and
display at least one of a plurality of receipts or receipt summaries associated with the first category.

9. A computer-implemented method, comprising:
receiving identification information associated with a user, the identification information being used to store electronic receipts for the user;
receiving, from a point-of-sale device, transaction information for a transaction involving the user;
generating an electronic receipt for the transaction; and
storing the electronic receipt.

10. The computer-implemented method of claim 9, further comprising:
receiving, from the user, a request for access to a plurality of electronic receipts associated with the user; and
providing the plurality of receipts to the user.

11. The computer-implemented method of claim 9, wherein the providing comprises:
transmitting the plurality of receipts in summary form for display.

12. The computer-implemented method of claim 9, further comprising:
receiving, from the user, categorization information identifying a plurality of categories associated with electronic receipts stored for the user; and
storing the electronic receipts in accordance with the categorization information.

13. The computer-implemented method of claim 12, further comprising:
receiving, from the user, a request for receipts associated with a first one of the plurality of categories; and
transmitting receipt information for the first category to a device associated with the user.

14. The computer-implemented method of claim 9, further comprising:
forwarding discount information, coupons or special offers to a mobile device associated with the user in response to receiving the transaction information.

15. The computer-implemented method of claim 9, further comprising:
determining whether the user has adequate funds in an account associated with the user for completing the transaction.

16. The computer-implemented method of claim 9, further comprising:
receiving a return indication associated with at least one item included in the electronic receipt; and
modifying the electronic receipt to indicate that the at least one item was returned.

17. The computer-implemented method of claim 9, further comprising:
storing electronic receipts for a plurality of users, wherein each of the plurality of users has a corresponding identifier; and
providing access to electronic receipts associated with one of the plurality of users in response to a request that includes an identifier corresponding to the one of the plurality of users.

18. A point-of-sale device, comprising:
an input device configured to receive an identifier associated with a user of a mobile device;
logic configured to receive information associated with a transaction between the user of the mobile device and a retailer associated with the point-of-sale device; and
a communication interface configured to forward, via a network, information associated with the transaction to a first system, wherein the first system is configured to generate an electronic receipt associated with the transaction.

19. The device of claim 18, wherein the input device includes at least one of a scanner to scan a barcode encoding the identifier or a radio frequency interface configured to receive the identifier via a wireless medium.

20. The device of claim 18, wherein the logic is further configured to:
receive at least one of coupon codes or discount codes from the first system or scan coupon codes or discount codes displayed by the mobile device.
